(19) United States
(12) Patent Application Publication
(10) Pub. No.: US 2024/0308177 A1
(43) Pub. Date: Sep. 19, 2024

(54) INFLATABLE SUPPORT ARTICLE

(71) Applicant: Milliken & Company, Spartanburg, SC (US)

(72) Inventors: John A. Sollars, JR., LaGrange, GA (US); Ramesh Keshavaraj, Inman, SC (US)

(21) Appl. No.: 18/583,377

(22) Filed: Feb. 21, 2024

Related U.S. Application Data
(60) Provisional application No. 63/490,323, filed on Mar. 15, 2023.

(51) Int. Cl. B32B 5/06; A01K 1/035; A47C 27/08; A47G 9/06; B32B 5/02

(52) U.S. Cl. CPC B32B 5/073; A47C 27/081; B32B 5/024; A01K 1/035; A47G 9/062; B32B 2250/20; B32B 2255/02; B32B 2255/26; B32B 2262/0261; B32B 2262/0276; B32B 2307/7242; B32B 2479/00

(57) ABSTRACT

An inflatable support article containing a multi-layer woven fabric and an air impermeable layer covering the majority of the multi-layer woven fabric. The multi-layer woven fabric has a first and second side and a middle region. At least a portion of the multi-layer woven fabric is woven as four woven layers, layers A, B, C, and D. Each of the woven layers A-D within the multi-layer woven fabric contain a repeating pattern of a first section where the woven layer forms the first side of the multi-layer woven fabric, a second section where the woven layer travels through the multi-layer woven fabric in the middle region of the multi-layer woven fabric, and a third section wherein the woven layer forms the second side of the multi-layer woven fabric. The woven layers A, B, C, and D cross-through each other within the multi-layer woven fabric.

### RELATED APPLICATIONS

This application claims priority to co-pending U.S. Provisional Application No. 63/490,323, filed on Mar. 15, 2023, and its contents are herein incorporated by reference in their entirety.

### TECHNICAL FIELD OF THE INVENTION

The present invention is directed towards inflatable support articles, more particularly, multi-layer woven inflatable support articles for mattresses and cushions.

### BACKGROUND

Inflatable air mattresses and cushions are typically manufactured by bonding, sealing, or welding layers of impermeable material that can include polymer sheets or textile reinforced material incorporating an impermeable membrane, film or coating. This material is then formed into an inflatable structure with internal connections added to control the inflated shape. These prior art methods of making inflatable support articles tend to be very complex, expensive and time consuming to make, and can use environmentally unfriendly materials, and are prone to have limitations in strength that can lead to mechanical failure or leakage. It would be desirable to have an inflatable structure that has a simpler construction and better manufacturing process.

### BRIEF SUMMARY OF THE INVENTION

The invention relates to an inflatable support article containing a multi-layer woven fabric and an air impermeable layer covering the majority of the first and second sides of the multi-layer woven fabric. The multi-layer woven fabric has a first side, a middle region, a second side and has warp yarns and weft yarns. At least a portion of the multi-layer woven fabric is woven as four woven layers, layer A, layer B, layer C, and layer D. Each of the woven layers A, B, C, and D within the multi-layer woven fabric contain a repeating pattern of a first section where the woven layer forms the first side of the multi-layer woven fabric, a second section where the woven layer travels through the multi-layer woven fabric in the middle region of the multi-layer woven fabric, and a third section wherein the woven layer forms the second side of the multi-layer woven fabric. The woven layers A, B, C, and D cross-through each other within the multi-layer woven fabric.

The invention also relates to an inflatable support article containing a multi-layer woven fabric and an air impermeable layer covering the majority of the first and second sides of the multi-layer woven fabric. The multi-layer woven fabric has a first side, a middle region, a second side and has warp yarns and weft yarns which are woven together in three woven layers, layer A, layer B, and layer C. Each of the woven layers A, B, and C within the multi-layer woven fabric contain a repeating pattern of a first section where the woven layer A forms the first side of the multi-layer woven fabric, a second section where the woven layer A travels through the multi-layer woven fabric in the middle region of the multi-layer woven fabric, and a third section wherein the woven layer A forms the second side of the multi-layer woven fabric. The woven layers A, B, and C cross-over each other within the multi-layer woven fabric.

### BRIEF DESCRIPTION OF THE DRAWINGS

FIG. 1 is an illustration of a cross-section of one embodiment of the woven fabric of the invention having four woven layers.

FIGS. 2A and 2B are illustrations of two possible yarn paths of the layers where they intersect and cross from FIG. 1.

FIG. 3 is an illustration of a cross-section of one embodiment of the woven fabric of the invention having three woven layers.

FIG. 4A is photograph of one embodiment of the inflatable support article of the invention. FIG. 4B is an illustration of the photograph of FIG. 4A.

FIG. 5A is cross-sectional photograph of one embodiment of the invention shown in FIG. 4A. FIG. 5B is illustration of the photograph of FIG. 5A.

### DETAILED DESCRIPTION

The inflatable support article is a woven fabric containing multiple layers of fabric which are connected by means such as crossing yarns from one layer to the next, or interweaving layers together at locations to connect the layers. This woven fabric typically consists of 3 or 4 total woven layers, although there may situations where 5 or more layers may be made using the same concepts if the application demanded it. The top and bottom surfaces are preferably coated or laminated with rubber, elastomer, or the like to make the surface airtight and capable of being inflated.

The inflatable support article may be any suitable article where someone or something is supported. One of the largest end uses for these inflatable support articles are mattresses. Other articles include, but are not limited to, pet beds, couches, cushions (attached or separate from a seating structure), airplane seating, camping pads/mattresses, and pool floats.

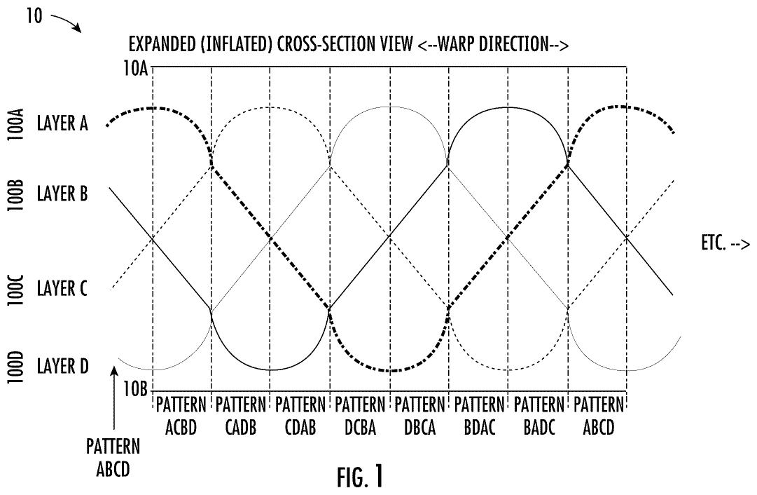

Referring now to FIG. 1, there is shown a portion of one embodiment of the multi-layer woven fabric 10. This embodiment of the multi-layer woven fabric 10 contains four woven layers, 100A, 100B, 100C, and 100D and shows how each layer crosses and interacts with the other layers. When describing the layers movement, the woven fabric layers will be referred to as A-D (corresponding to layers 100A-D) for ease of reading. This embodiment has a repeating pattern of eight different sections, where each section has a different configuration of layers within it and at least 2 layers cross through each other between each of the sections. Where the layers cross-through each other forms a cross-through seam. Each woven layer A-D contains warp yarns interwoven with weft yarns. In one embodiment, the woven layers of the multi-layer woven fabric 10 are in a plain weave, though other weaves may be utilized. In a preferred embodiment, each woven layer within the multi-layer woven fabric has the same weave pattern.

In one embodiment, the multi-layer woven fabric 10 is made as a one-piece woven fabric, where the multi-layer fabric 10 is made with all of the layers being woven together simultaneously on the same loom. This would be a preferred way of making the woven fabric for because the connections between the top and bottom surfaces, and the shape defining internal layers are integral with each other and inherently stronger than if the connections are glued, welded, or otherwise bonded. The top and bottom surfaces along with the shape defining inner layers come from the loom already in their final shape, eliminating the need for time consuming assembly steps to subsequently to fabricate and add the internal shape defining elements.

Each of the woven layers A, B, C, and D within the multi-layer woven fabric comprise a repeating pattern of a first section where the woven layer forms the first side of the multi-layer woven fabric, a second section where the woven layer travels through the multi-layer woven fabric in the middle region of the multi-layer woven fabric, and a third section wherein the woven layer forms the second side of the multi-layer woven fabric, wherein the woven layers A, B, C, and D cross-through each other within the multi-layer woven fabric.

The woven fabric contains an upper surface 10a and a lower surface 10b and an inner area. Starting at the left side of the portion the woven fabric 10 shown in FIG. 1, in the first pattern section layer A forms the upper surface 10a of the woven fabric 10, layers B and C are within the inner area, and layer D forms the lower surface 10b. This first section of the woven fabric has the pattern ABCD.

The next (second) section has the pattern ACBD, and at the interface between the ABCD pattern and the ACBD pattern, the layers B and C cross through one another and change position within the inner area of the woven fabric. In the ACBD pattern area, the layer A still forms the upper surface 10a and the layer D still forms the lower surface, but the layers C and B have switched positions, with layer C being closer to the upper surface and layer B being closer to the lower surface.

The third section has the pattern CADB, and at the interface between the ACBD pattern and the CADB pattern, the layers A and C cross through one another and change position and the layers B and D cross through one another and change position. In the CADB section, the layer C forms the upper surface 10a and the layer B forms the lower surface, and the layers A and D are located within the inner area, with layer A being closer to the upper surface and layer D being closer to the lower surface.

The fourth section has the pattern CDAB, and at the interface between the CADB pattern and the CDAB pattern, the layers A and D cross through one another and change position within the inner area of the woven fabric. In the CDAB pattern area, the layer C forms the upper surface 10a and the layer B forms the lower surface, but the layers D and A have switched positions, with layer D being closer to the upper surface and layer A being closer to the lower surface.

The fifth section has the pattern DCBA, and at the interface between the CDAB pattern and the DCBA pattern, the layers C and D cross through one another and change position and the layers A and B cross through one another and change position. In the DCBA section, the layer D forms the upper surface 10a and the layer A forms the lower surface, and the layers C and B are located within the inner area, with layer C being closer to the upper surface and layer B being closer to the lower surface.

The sixth section has the pattern DBCA, and at the interface between the DCBA pattern and the DBCA pattern, the layers B and C cross through one another and change position within the inner area of the woven fabric. In the DBCA pattern area, the layer D forms the upper surface 10a and the layer A forms the lower surface, but the layers B and C have switched positions, with layer B being closer to the upper surface and layer C being closer to the lower surface.

The seventh section has the pattern BDAC, and at the interface between the DBCA pattern and the BDAC pattern, the layers B and D cross through one another and change position and the layers A and C cross through one another and change position. In the BDAC section, the layer B forms the upper surface 10a and the layer C forms the lower surface, and the layers D and A are located within the inner area, with layer D being closer to the upper surface and layer A being closer to the lower surface.

The eighth section has the pattern BADC, and at the interface between the BDAC pattern and the BADC pattern, the layers A and D cross through one another and change position within the inner area of the woven fabric. In the BADC pattern area, the layer B forms the upper surface 10a and the layer C forms the lower surface, but the layers A and D have switched positions, with layer A being closer to the upper surface and layer D being closer to the lower surface.

After the eighth section (pattern BADC), the layers A and B cross through one another and change position and the layers C and D cross through one another and change position to now bring back the first section (pattern ABCD). While this embodiment has a repeating pattern of 8 sections, the repeat can be any suitable number to make the resultant structure weavable and practical.

Having the woven layers cross through each other and switching positions through the woven fabric 10 is preferred for ease of weaving. If the lengths of the paths of the layers A-D were not equal and symmetrical then the warp yarns forming the layers would become more and more unbalanced as woven during the (some of the layers would be shorter than others so some layers would be looser and some tighter) and would be difficult to weave correctly. Having the layer movement symmetrical from end to end also helps achieve increased and consistent thickness relative to the distance on the surface between internal connections.

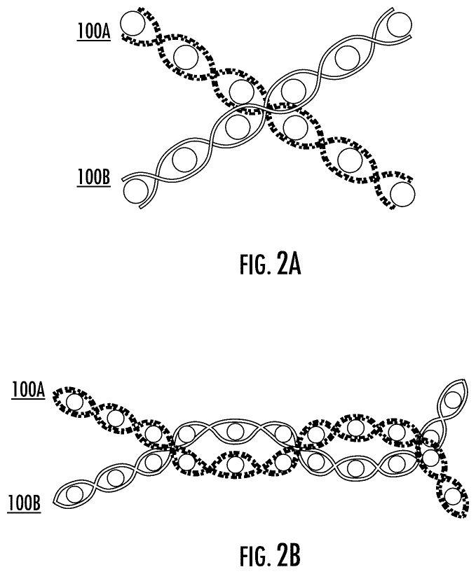

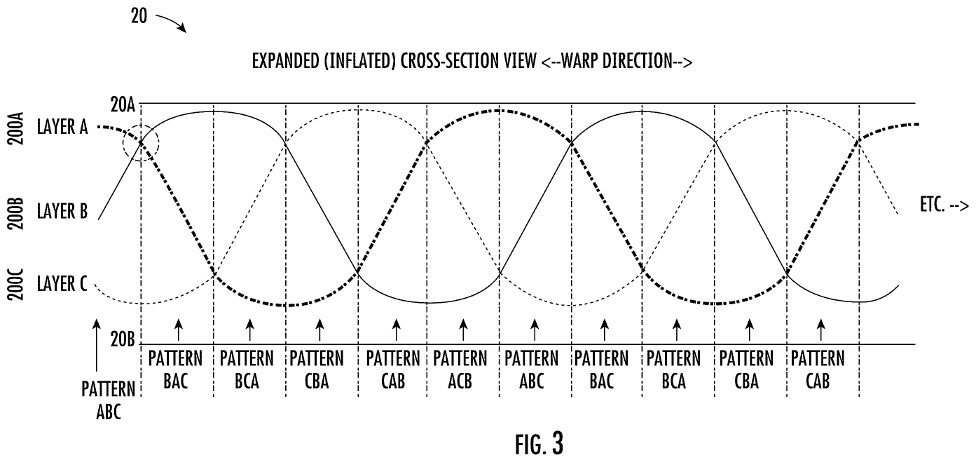

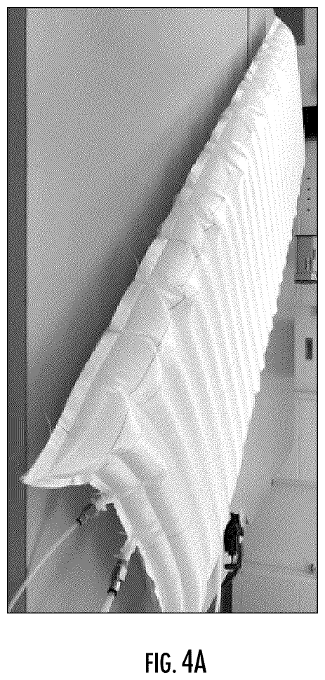

This sequence of patterns and the relative distance used by each pattern as shown in FIG. 1 may be consistent throughout the length (weft direction of the fabric) or can change vary. For example, as the pattern changes in sections (1-8) across the warp direction, the pattern may also be changed in the weft direction (in any number of suitable patterns). This may create areas with connections and differing thickness or other characteristics along both the length and width of the fabric 10.

Where the woven layers pass through one another can have multiple different stitch paths. FIG. 2A illustrates one possible cross-through method. FIG. 2A shows layers A and B (100A and 100B) crossing through each other. The circles are the weft (or fill) yarns coming out of the page and the lines shown are the warp yarns. As one can see from the illustration, the warp yarns pass through one another one. FIG. 2B illustrates another possible cross-through method. FIG. 2B shows layers A and B (100A and 100B) crossing through each other. The circles are the weft (or fill) yarns coming out of the page and the lines shown are the warp yarns. As one can see from the illustration, the warp yarns pass through three times (this would have the same effect as the single cross over shown in FIG. 2A in such that after the third cross-over, the layers would return back to the sequence as shown in FIG. 1 or FIG. 3). There would typically be a relatively small number if yarns between the crossing points as shown in FIG. 2B, but the number can vary to achieve a desired fabric characteristic. You can see that in both of these examples, the warp yarns from the two layers always stay woven with their weft yarns (never switching weft yarns with an adjacent layer. But there are embodiments where this may preferably happen, and the weft yarns may move from one layer to another layer.

Referring now to FIG. 3, there is shown another embodiment of multi-layer woven fabric 20 having three layers 200A, 200B, 200C (called layers A, B, C herein for simplicity). In this embodiment with three layers, there is a pattern of 6 repeating sections, though the multi-layer woven fabric 20 may have any suitable number of repeating sections.

The multi-layer woven fabric 20 contains an upper surface 20a and a lower surface 20b and an inner area. Starting at the left side of the illustrated portion the multi-layer woven fabric 20 of FIG. 3A, in the first pattern section layer A forms the upper surface 20a of the woven fabric 10, layer B is within the inner area, and layer C forms the lower surface 20b. This first section of the woven fabric has the pattern ABC.

The next (second) section has the pattern BAC and at the interface between the ABC pattern and the BAC pattern, the layers A and B cross through one another and change position. In the BAC pattern area, the layer B forms the upper surface, the layer C forms the lower surface, and the layer A is in the middle area.

The third section has the pattern BCA and at the interface between the BAC pattern and the BCA pattern, the layers A and C cross through one another and change position. In the BCA pattern area, the layer B forms the upper surface, the layer A forms the lower surface, and the layer C is in the middle area.

The fourth section has the pattern CBA and at the interface between the BCA pattern and the CBA pattern, the layers C and B cross through one another and change position. In the CBA pattern area, the layer C forms the upper surface, the layer A forms the lower surface, and the layer B is in the middle area.

The fifth section has the pattern CAB and at the interface between the CBA pattern and the CAB pattern, the layers A and B cross through one another and change position. In the CAB pattern area, the layer C forms the upper surface, the layer B forms the lower surface, and the layer A is in the middle area.

The sixth section has the pattern ACB and at the interface between the CAB pattern and the ACB pattern, the layers A and C cross through one another and change position. In the ACB pattern area, the layer A forms the upper surface, the layer B forms the lower surface, and the layer C is in the middle area. After the sixth pattern, the next pattern is back to the first ABC pattern.

The cross throughs within the multi-layer woven fabric 20 of FIG. 3A can be similar to the stitch paths of the four layered multi-layer woven fabric 10 (shown in FIGS. 2A and 2B).

The examples cited previously of the three layer and the four-layer embodiments would have different characteristics or potential advantages over each other depending on the application. As an example, the three-layer embodiment would use less raw materials while the four-layer embodiment would be symmetrical and have a smoother top or bottom surfaces.

In some embodiments, the multi-layer fabric may contain an additional portion containing two woven layers or one woven layer. These additional areas most often would be found along the edge of the support article.

The woven layers within the woven fabric 10, 20 form a plurality of chambers within the multi-layer woven fabric. Preferably the chambers are air permeable to other chambers with the woven fabric meaning that air can travel from one chamber to another chamber. The woven layers that connect the upper and lower surfaces of the woven fabric 10, 20 together serve to constrain the woven fabric when inflated to keep a set thickness (and not just blow up like a balloon).

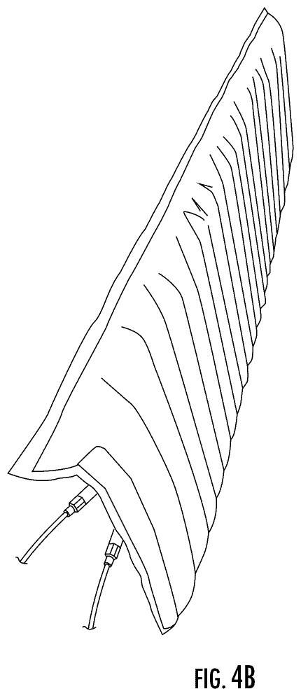

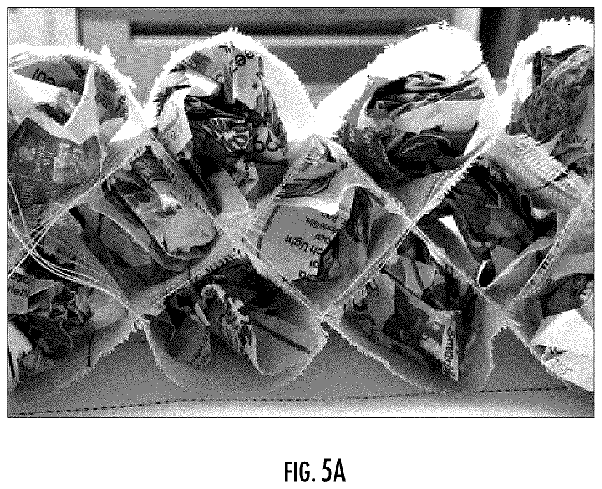

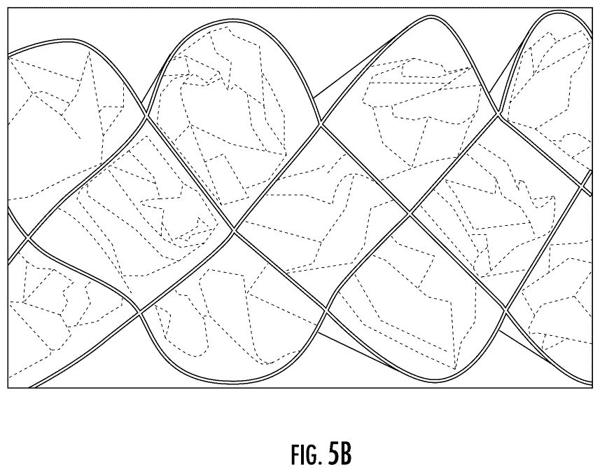

FIG. 4A shows a photograph of one embodiment of an inflatable support article having four layers. FIG. 4B is an illustration of the photograph of FIG. 4A. The inflatable support article in the photograph is inflated and is air impermeable over most (if not all of its surface). It also contains at least one area to introduce air into and may have inputs, outputs, and measurement devices connected. A photograph of the cross-section of the inflatable support article of FIG. 4A is shown as FIG. 5A. Newspaper was stuffed into the chambers to hold them open for the photograph. FIG. 5B is an illustration of the photograph of FIG. 5A.

The yarns of the fabric 10, 20 may be formed of (but are not limited to) cellulosic yarns (such as cotton, rayon, linen, jute, hemp, cellulose acetate, and combinations, mixtures, or blends thereof), polyester yarns (e.g., poly(ethylene terephthalate) yarns, poly(propylene terephthalate) (PET) yarns, poly (trimethylene terephthalate) yarns), poly(butylene terephthalate) yarns, and blends thereof), polyamide yarns (e.g., nylon 6 yarns, nylon 6,6 yarns, nylon 4,6 yarns, and nylon 12 yarns), polyvinyl alcohol yarns, an elastic polyester-polyurethane copolymer (SPANDEX®), polypropylene yarns, polyethylene yards, polyvinyl acetate yarns, polylactic acid yarns, flame-resistant meta-aramid (NOMEX®) or para-aramid, and combinations, mixtures, or blends thereof.

In one preferred embodiment, the woven fabric contains multifilament polyester yarns as these have been shown to have good performance at low cost. In another embodiment, the woven fabric contains nylon yarns. In one embodiment, all of the yarns of the fabric 10, 20 have approximately the same thickness or denier. In other embodiments, there is a difference in denier. In another embodiment, there may be more than one type of yarn within a woven layer (varying in materials, construction, and/or denier) or the yarns used may contain more than one type of fiber.

The inflatable support article has an air impermeable layer covering the majority of the first and second sides of the multi-layer woven fabric. Preferably, this air impermeable layer covers almost the entire surface area of the woven fabric, more preferably covers at least 95% of the surface area of the woven fabric.

The air impermeable layer may contain any suitable materials. The materials may be, for example but not limited to, elastomeric polymer, rubber, urethane, silicone, polyvinyl chloride, and mixtures thereof. The support article preferably holds an air pressure of at least three fourths (75%) of an initial inflating pressure chosen between in a range of between 16.9 and 20.7 kPa (1.0 and 3.0 PSI) for at least 24 hours.

The air impermeable layer may be applied to the woven fabric in any suitable manner such as coating, spraying, printing, gravure printing, dip coating, knife or blade coating, curtain coating, or lamination using either a liquid or solid adhesive that bonds using heat and/or pressure.

An example inflatable support article shown in FIG. 6A was made using the weave pattern shown in FIG. 1 using 1,000 denier polyester yarns. Once the woven fabric was made, it was coated with a silicone-based coating. A more preferred embodiment may be made using lighter weight yarns, and an alternative impermeable layer from the choices listed previously.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. An inflatable support article comprising:
a multi-layer woven fabric having a first side, a middle region, a second side and having warp yarns and weft yarns, wherein in at least a portion of the multi-layer woven fabric is woven as four woven layers, layer A, layer B, layer C, and layer D,
wherein each of the woven layers A, B, C, and D within the multi-layer woven fabric comprise a repeating pattern of a first section where the woven layer forms the first side of the multi-layer woven fabric, a second section where the woven layer travels through the multi-layer woven fabric in the middle region of the multi-layer woven fabric, and a third section wherein the woven layer forms the second side of the multi-layer woven fabric, wherein the woven layers A, B, C, and D cross-through each other within the multi-layer woven fabric;
an air impermeable layer covering the majority of the first and second sides of the multi-layer woven fabric.

2. The inflatable support article of claim 1, wherein each of the woven layers A-D are woven layers containing warp and weft yarns.

3. The inflatable support article of claim 1, wherein each woven layer within the multi-layer woven fabric has the same weave pattern.

4. The inflatable support article of claim 1, wherein multi-layer woven fabric is a one-piece woven fabric.

5. The inflatable support article of claim 1, wherein the wherein the woven layers A, B, C, and D cross-through each other forming a cross-through seam.

6. The inflatable support article of claim 1, wherein the first side of the multi-layer woven fabric is formed by the woven layers A, B, C, and D in the repeating pattern comprising portions of layer A, layer C, layer D, then layer B.

7. The inflatable support article of claim 1, wherein the woven layers A, B, C, and D form a plurality of chambers within the multi-layer woven fabric.

8. The inflatable support article of claim 9, wherein the chambers are air permeable to other chambers within the multi-layer woven fabric.

9. The inflatable support article of claim 1, wherein the multi-layer woven fabric comprises an addition portion containing two woven layers.

10. The support article of claim 1, wherein the multi-layer woven fabric comprises a portion containing one woven layer.

11. The inflatable support article of claim 1, wherein the support structure is selected from the list consisting of a mattress, a camping mat, a cushion, and a pet bed.

12. The inflatable support article of claim 1, wherein the support article holds an air pressure of at least three fourths (75%) of an initial inflating pressure chosen between in a range of between 16.9 and 20.7 kPa (1.0 and 3.0 PSI) for at least 24 hours.

13. The inflatable support article of claim 1, wherein the air impermeable layer comprises a material selected from the group consisting of an elastomeric polymer, rubber, urethane, silicone, polyvinyl chloride, and mixtures thereof.

14. An inflatable support article comprising:
a multi-layer woven fabric having a first side, a middle region, a second side and having warp yarns and weft yarns which are woven together in three woven layers, layer A, layer B, and layer C,
wherein each of the woven layers A, B, and C within the multi-layer woven fabric comprise a repeating pattern of a first section where the woven layer A forms the first side of the multi-layer woven fabric, a second section where the woven layer A travels through the multi-layer woven fabric in the middle region of the multi-layer woven fabric, and a third section wherein the woven layer A forms the second side of the multi-layer woven fabric, wherein the woven layers A, B, and C cross-over each other within the multi-layer woven fabric;
an air impermeable layer covering the majority of the first and second sides of the multi-layer woven fabric.

15. The inflatable support article of claim 14, wherein each of the woven layers A-C are woven layers containing warp and weft yarns.

16. The inflatable support article of claim 14, wherein multi-layer woven fabric is a one-piece woven (OPW) fabric.

17. The inflatable support article of claim 14, wherein the wherein the woven layers A, B, and C cross-through each other forming a cross-through seam.

18. The inflatable support article of claim 14, wherein the first side of the multi-layer woven fabric is formed by the woven layers A, B, C in the repeating pattern comprising portions of layer A, layer C, then layer B.

19. The support article of claim 14, wherein the multi-layer woven fabric comprises a portion containing one woven layer.

20. The inflatable support article of claim 14, wherein the support structure is selected from the list consisting of a mattress, a camping mat, a cushion, and a pet bed.
